(19) United States
(12) Patent Application Publication
(10) Pub. No.: US 2006/0213567 A1
(43) Pub. Date: Sep. 28, 2006

(54) Non-whistling vent tube

(76) Inventors: David B. Parpart, Warren, MI (US); Kevin Baxter, Goodrich, MI (US); C. Joseph Thielen, Shelby Township, MI (US)

Correspondence Address: HARNESS, DICKEY & PIERCE, P.L.C., P.O. BOX 828, BLOOMFIELD HILLS, MI, 48303, US

(21) Appl. No.: 11/090,881

(22) Filed: Mar. 25, 2005

(51) Int. Cl. F16L 11/00

(52) U.S. Cl. 138/121

(57) ABSTRACT

A non-whistling corrugated tube is provided having a plurality of rib segments interleaved between a plurality of root segments. Each of the rib segments include a pair of axially converging sidewalls intersecting with an apex wall. The geometry of the tube is such that the rib-to-root volume ratio is in the range of 0.1 to 0.2. Corrugated tubes having these geometric configurations have been found to be superior to conventional corrugated tubing for attenuating airborne noise generated by fluid flow therethrough, i.e., whistling.

### FIELD OF THE INVENTION

The present invention relates to a corrugated tube and, more particularly, to a corrugated tube with attenuating acoustics associated therewith to prevent whistling resulting from the flow of air through the tube in either direction.

### BACKGROUND OF THE INVENTION

Corrugated tubing is commonly used in venting and draining systems. Typical corrugated tubing includes a plurality of root segments interleaved with a plurality of rib segments. The rib segments have larger diameters than the root segments. This geometrical configuration provides for a flexible tube. The alternating root and rib segments are typically uniformly spaced. The uniform spacing of the root and rib segments, as well as the changing diameter of the corrugated tube, create a flow condition which often generates or amplifies standing acoustical waves associated with a fluid flowing therethrough. Such acoustical waves are typically found to be undesirable in most applications.

### SUMMARY OF THE INVENTION

A corrugated tube is provided including a plurality of root segments and a plurality of rib segments. The plurality of root segments each include an axial root dimension. The plurality of rib segments are interleaved between the plurality of root segments. The plurality of rib segments each include a pair of axially converging sidewalls intersecting with an apex wall. The apex wall includes an axial apex dimension that is smaller than the axial root dimension. The ratio of the root segment volume to the rib segment volume, along with the converging sidewalls provide a tube geometry in which the pressure fluctuations along the length of the tube are minimized to the point where a standing wave does not establish itself within the tube. In this way, the present invention provides a symmetric geometric configuration which simplifies the manufacturing process, while at the same time provides an acoustic attenuation function.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a corrugated tube in accordance with the principles of the present invention;

FIG. 2 is a side view of the corrugated tube of FIG. 1;

FIG. 3 is a partial cross-sectional side view of the corrugated tube taken through line III-III of FIG. 2;

FIG. 4 is an exploded perspective view illustrating individual root segment volumes and rib segment volumes;

FIG. 5 is a schematic illustration showing a flow condition in a conventional corrugated tube establishing a standing wave; and

FIG. 6 is a schematic illustration showing the present invention with a similar flow condition to that shown in FIG. 5.

### DETAILED DESCRIPTION OF THE PREFERRED EMBODIMENTS

The following description of the preferred embodiment is merely exemplary in nature and is in no way intended to limit the invention, its application, or uses.

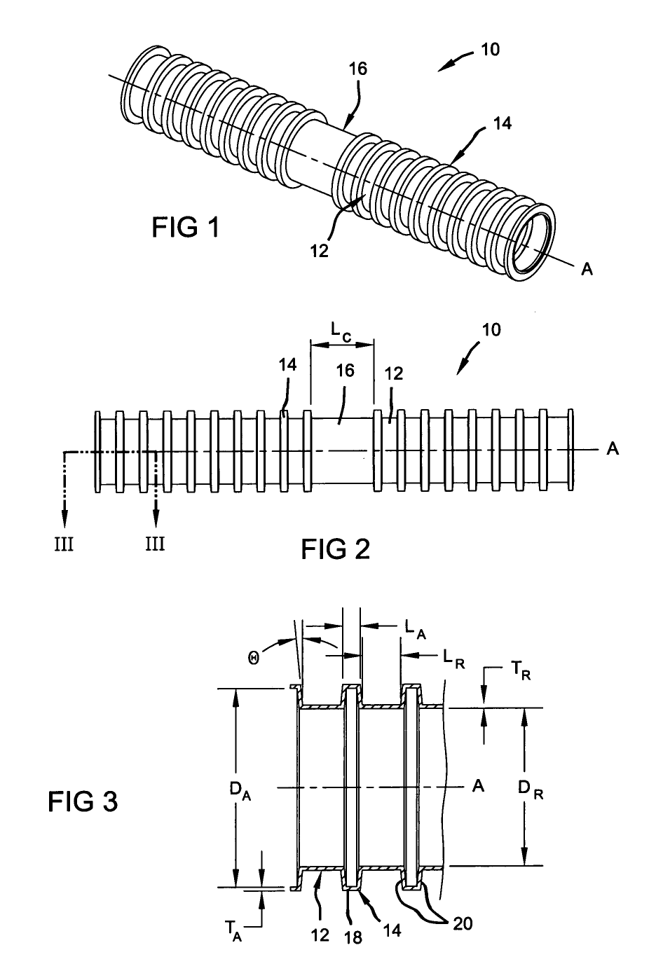

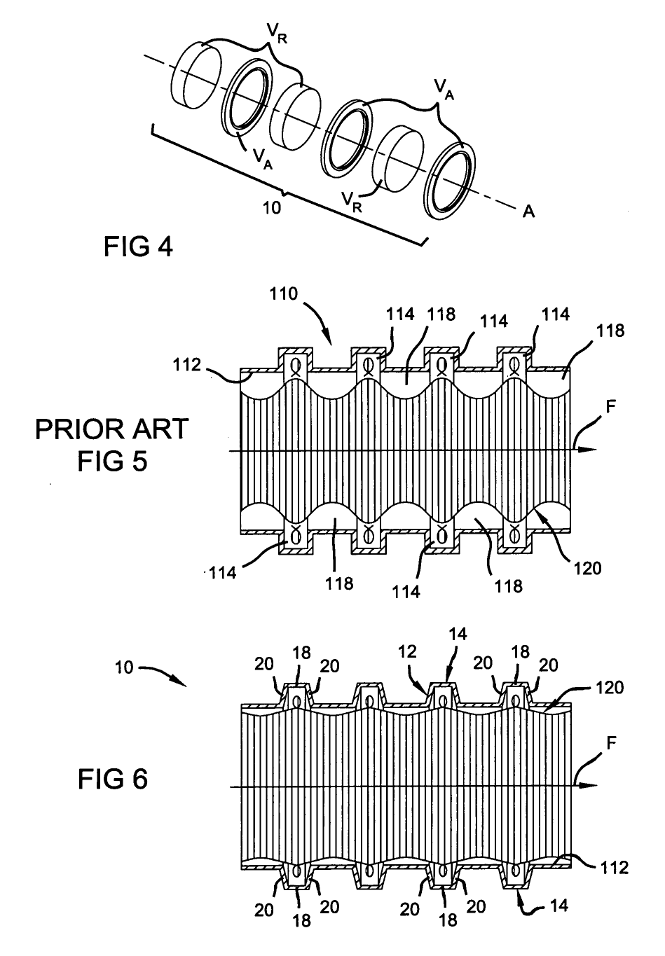

FIGS. 1-4 depict a corrugated tube 10 including a plurality of root segments 12, a plurality of rib segments 14, and a component segment 16. The plurality of rib segments 14 are integrally formed with and interleaved between the plurality of root segments 12. The component segment 16 is integrally formed between adjacent sets of root segments 12 and rib segments 14. The component segment 16 provides a relatively smooth, constant diameter region for receiving a component part (not shown) such as a bracket, hose clamp or tube clip. Thus, the corrugated tube 10 has a symmetric geometric configuration while providing an acoustic attenuation function.

The corrugated tube 10 is adapted to contain a fluid flow, such as air or fuel vapor in either direction, and attenuate at least one acoustical wave associated therewith. For example, the present invention has utility in a fuel system venting application which may require a two-way fluid flow.

The plurality of root segments 12 are generally cylindrical having a substantially uniform circular cross-section disposed along a longitudinal axis A. Each of the plurality of root segments 12 includes root diameter D_{R}, an axial root length L_{R} which defines a root segment volume V_{R}. The wall thickness T_{R} of the root segment is substantially constant along its length.

The plurality of rib segments 14 are generally annular having a substantial uniform cross-section disposed along the longitudinal axis A. Each of the plurality of rib segments include an apex wall 18 and a pair of sidewalls 20 extending from the root segment 12 to the apex wall 18. The apex walls 18 are generally cylindrical having a substantially uniform circular cross-section. The apex wall 18 of each of the rib segments 14 include an apex diameter D_{A} and an axial apex length L_{A}. The sidewalls 20 of each rib segment 14 are generally radially disposed with respect to the longitudinal axis A between the root segments 12 and the apex walls 18 of the rib segment 14. Each sidewall 20 axially converges toward the apex wall 18 at an angle θ. Each rib segment 14 defines a rib segment volume V_{A}. The wall thickness T_{A} of the rib segment may vary depending on the forming operation used to fabricate the corrugated tubing, and is typically less than or equal to the wall thickness T_{R} of the root segment.

It is believed that the whistling characteristic of conventional corrugated tubing results for a standing wave established along the length of the tube. With specific reference to FIG. 5, a fluid flows through tubing 110 in the direction of arrow A. Fluid traveling near the inner wall 112 will flow into the rib segment volume 114 and tend to significantly slow down or stagnate therein resulting in a locally higher pressure region in the rib. When the local pressure is high enough, a slug of fluid is shed from the rib back into the flow through the root segment volume 118, creating a locally higher pressure region therein. When the rib segments are evenly distributed along the length of the tubing, the pressure-shedding phenomena creates a repeating pattern that establishes a standing wave 120 within the tube 110. Under proper flow velocity, the period of the standing wave is such that it falls within the audible range of the human ear. This may include acoustical waves having frequency ranges between 100 and 20,000 hertz.

In accordance with the present invention, it has been found that the adverse pressure effects generated in conventional corrugated tubing can be minimized to a point where a standing wave fails to establish within the tube. With reference to FIGS. 6, a fluid flows through tubing 10 in the direction of arrow F. Fluid traveling near the inner wall 112 will tend to diverge towards the rib segment volume. However, the converging sidewalls 20, and in particular the sidewall on the downstream side, promote fluid flow into and out of the rib segment, thereby preventing flow stagnation. Furthermore, the size of the root segment volume V_{R} relative to the rib segment volume V_{A}, as well as the spacing L_{R} of the rib segments along the tubing is such that the momentum of the fluid discharged from the rib segments is insufficient to significantly effect the flow characteristics of fluid within the root segment V_{R} of the tube 10. While local pressure variations 120 do exist along the length of the tubing, they are insufficient to establish a standing wave within the tube through the usable range of flow velocities for a given tube. It should be appreciated, however, that the corrugated tube 10 may be tuned to attenuate acoustical waves within a specific frequency range. For example, one skilled in the art will understand that the geometry of the corrugated tube 10 defines root segment volume V_{R} and the rib segment volume V_{A}. In particular, the root segment volume V_{R} is defined as a function of the root diameter D_{R}, the axial root length L_{R} and the axial apex length L_{A}. Likewise, the rib segment volume V_{A} is defined as a function of the rib diameter D_{R}, the apex diameter D_{A}, the axial apex length L_{A} and the sidewall angle θ. A solid or three-dimensional computer model of the corrugated tube 10 has been found to be a particularly useful and easy manner to compute the root and rib segment volumes. By way of example, a corrugated tube having a nominal diameter of 15.75 mm, sidewalls which converge 5°, a rib-to-root volume ratio (V_{A}/V_{R}) of 6.5 and a root length-to-diameter ratio (L_{R}/D_{R}) of 3.25 has been found to have superior anti-whistling characteristics for fluid flow in both direction and at a velocity range from 0 to 6 m/sec. The spacing between the rib segments 14 may also be increase to attenuate lower frequency acoustical waves or decreased to attenuate higher frequency acoustical waves while providing adequate flexibility for the tubing.

Thus, in accordance with the present invention, the geometry of a non-whistling tubing includes rib segments having sidewalls that converge from the root to apex at an angle greater than 3° and more preferably in the range of approximately 5° to 7°, and having a rib-to-root volume ratio, V_{A}/V_{R} (i.e., the ratio of the rib segment volume to the root segment volume) no greater than 0.2 and more preferably in the range of 0.1 to 0.2. The noise attenuating effect of the present invention can be further tuned by appropriately spacing the rib segments such that the length-to-diameter ratio L_{R}/D_{R} (i.e., the ratio of the axial root length to the root diameter) is no less than 0.27 and more preferably in the range of 0.28 to 0.35. The foregoing ratios are intended to define the geometric configuration of the tubing in a dimensionless manner such that features of the present invention may be scaled to achieve the desired acoustic attenuation function for a range of vent tube sizes. However, one skilled in the art will recognize that the ratios may vary within an acceptable range.

The above-described geometric relationships and characteristics of the corrugated tube 10 provide for the attenuation of acoustical waves generated by or associated with a gaseous fluid, such as air, flowing through the corrugated tube 10. The relative lengths of the root and rib segments 12, 14, as well as the angle θ of the sidewalls 20 of the rib segments 14, physically prevent a predetermined wavelength of acoustical waves from developing and/or resonating within the corrugated tube 10. Specifically, the pluralities of root segments 12 and rib segments 14 cooperate to attenuate acoustical waves perceived by the human ear.

Referring again to FIG. 1, the component portion 16 of the corrugated tube 10 is constructed similar to each of the plurality of root segments 12 with the exception of its axial dimension, referred to herein as the axial component length L_{C}. The axial component length L_{C} is larger than the axial root length L_{R}. This provides a greater area for a component such as a bracket, hose clamp or clip to engage the corrugated tube 10. It should be appreciated, however, that while the component portion 16 has been illustrated and described as being generally similar in cross-section to the plurality of root segments 12, any geometric form required to receive or be coupled to a supplemental device is intended to be within the scope of the present invention. For example, the component segment 16 may be formed to include a rib, a flange, or other geometry necessary for proper engagement with a component part. Furthermore, while the component segment 16 has been depicted and described as being located near a mid-region of the corrugated tube 10, a component segment 16 located at an end-region of the corrugated tube 10 is also intended to be within the scope of the present invention. For example, the component segment 16 may include a male or female portion disposed at an end-region for interconnecting multiple corrugated tubes 10 or attaching the corrugated tube 10 to a device such as a vacuum or exhaust system.

The corrugated tube 10 is constructed with a corrugator machine, as is well known in the art. A typical corrugator machine includes an extruder and a plurality of mold blocks. The extruder is located ahead from the plurality of mold blocks. The plurality of mold blocks are disposed on a pair of constantly rotating tracks, such that a predetermined number of corresponding pairs of mold blocks mate with each other at any given time to define a mold cavity. In an exemplary embodiment, approximately fifty pairs of mold blocks are constantly mating to define an elongated mold cavity.

Initially, a plastic and preferably polymer material is fed into the extruder via a hopper or similar device. The plastic is envisioned to include polypropylene, modified polypropylene, nylon, nylon propolymer, or any other material capable of serving the principles of the present invention. The plastic is then heated to a semi-liquid state and extruded down and around the length of a mandrel into the elongated mold cavity. A pressure differential is created by an internal pressure and/or external vacuum to draw plastic into the elongated mold cavity. This pressure differential forces the semi-liquid polymer against the walls of the mold blocks to form the corrugated tube 10. It should be appreciated that the mold blocks are formed to define the external geometry of the corrugated tube 10 as described in detail above. For example, each mold block is machined to include one or more annular recesses defining the apex walls 18 and sidewalls 20 of the plurality of rib segments 14. The annular recesses are machined in accordance with the geometrical ratios and angles discussed in detail above. Furthermore, it should be appreciated that the air flow resulting from the pressure differential applies a force substantially uniform across an internal surface of the corrugated tube 10 to define the thicknesses T_{R}, T_{A}.

Once the plastic has properly been formed, the air flow resulting from the pressure differential cools and solidifies the extruded plastic to form the corrugated tube 10. The continuous movement of the mold blocks on the rotating tracks carries the completed portions of the corrugated tube 10 away from the corrugator machine. It should be appreciated that this process enables the corrugated tube 10 to be manufactured to any conceivable length. Furthermore, to create the component segment 16 of the corrugated tube, one or more pair of the plurality of the corresponding mold blocks are simply swapped out for one or more pairs of alternative mold blocks. The alternative mold blocks mate to define a cavity having the desired external geometry of the component segment 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A non-whistling corrugated tube, comprising:
a plurality of root segments each of said plurality of root segments having an axial root length measured along a longitudinal axis;
a plurality of rib segments interleaved between said plurality of root segments and each of said plurality of rib segments having a pair of sidewalls extending from adjacent root segments and terminating at an apex wall, said apex wall having an axial apex length that is smaller than said axial root length.

2. The non-whistling corrugated tube of claim 1 wherein said plurality of root segments and said plurality of rib segments are coaxially aligned on said longitudinal axis.

3. The non-whistling corrugated tube of claim 1 wherein each of said plurality of rib segments has a base portion adjacent said adjoining root segment having a length which is greater than said axial apex length of said apex wall such that said pair of sidewalls comprises a pair of converging sidewalls.

4. The non-whistling corrugated tube of claim 3 wherein said pair of converging sidewalls converge at an angle of approximately five (5) degrees relative to an axis that is substantially perpendicular to said longitudinal axis.

5. The non-whistling corrugated tube of claim 1 wherein said plurality of root segments include a root diameter and said plurality of rib segments include a rib diameter that is larger than said root diameter.

6. The non-whistling corrugated tube of claim 1 wherein each of said plurality of root segments defines a root segment volume and each of said plurality of rib segments defines a rib volume, the non-whistling corrugated tube further comprising a ratio of said rib segment volume to said root segment volume which is less than 0.2.

7. The non-whistling corrugated tube of claim 6 wherein said ratio of said rib segment volume to said root segment volume is in the range of 0.1 and 0.2.

8. The non-whistling corrugated tube of claim 6 wherein each of said plurality of root segments defines a root diameter such that a ratio of said axial root length to said inner root diameter is greater than 0.27.

9. The non-whistling corrugated tube of claim 8 wherein said ratio of said axial root length to said root diameter is in the range of 0.28 and 0.35.

10. The non-whistling corrugated tube of claim 1 further comprising a component portion having an axial component dimension substantially greater than said axial root dimension.

11. A non-whistling corrugated tube, comprising:
a root segment having a root diameter and a longitudinal axis; and
a plurality of rib segments extending radially from said root segment and equally spaced apart therealong at a spaced dimension, each of said plurality of rib segments having a pair of sidewalls extending from said root segment to an apex wall;
a root segment volume defined by said root diameter and said spaced dimension; and
a rib segment volume defined by a length of said rib segment adjacent said root segment, a length of rib segment at said apex wall and a height of said pair of sidewalls;
wherein a rib-to-root volume ratio defined by a quotient of said rib segment volume and said root segment volume is less than 0.2.

12. The non-whistling corrugated tube of claim 11 wherein said rib-to-root ratio is in the range of 0.1 and 0.2.

13. The non-whistling corrugated tube of claim 11 wherein said plurality of root segments include an inner root diameter and said plurality of rib segments include an inner rib diameter that is larger than said inner root diameter.

14. The non-whistling corrugated tube of claim 11 wherein said plurality of rib segments each include a pair of axially converging sidewalls intersecting said apex wall.

15. The non-whistling corrugated tube of claim 14 wherein said apex wall includes a substantially uniform radial dimension and said pair of axially converging sidewalls intersect said apex wall at an angle approximately five (5) degrees relative to an axis which is perpendicular to the longitudinal axis.

16. The non-whistling corrugated tube of claim 11 wherein said root segment has a nominal diameter and wherein a length-to-diameter ratio defined by a quotient of said spaced dimension and said nominal diameter is greater than 0.27.

17. The non-whistling corrugated tube of claim 16 wherein said ratio of said spaced dimension to said nominal diameter is in the range of 0.28 and 0.35.

18. The non-whistling corrugated tube of claim 11 further comprising a component portion having an axial component dimension substantially greater than said axial root dimension.

19. A non-whistling corrugated tube, comprising:
a plurality of root segments, each of said plurality of root segments including an axial root length and a root diameter;
a plurality of rib segments interleaved between said plurality of root segments, each of said plurality of rib segments having a pair of sidewalls extending radially outwardly from an adjacent root segment and converging at an apex wall;
a root segment volume defined by said axial root length and said root diameter; and
a rib segment volume defined by a length of said rib segment adjacent said root segment, a length of rib segment at said apex wall and a height of said pair of converging sidewalls and an angle of convergence;
wherein a rib-to-root volume ratio defined by a quotient of said root segment volume and said rib segment volume is less than 0.2;
wherein said angle of convergence is greater than 3°; and
wherein a length-to-diameter ratio defined by a quotient of said axial root length and said root diameter is greater than 0.27.

20. The non-whistling corrugated tube of claim 19 wherein a rib-to-root volume ratio defined by a quotient of said root segment volume and said rib segment volume is in the range of 0.1 and 0.2, wherein said angle of convergence is in the range of 3° and 7°, and wherein a length-to-diameter ratio defined by a quotient of said axial root length and said root diameter is in the range of 0.28 and 0.35.
